(19) United States
(12) Patent Application Publication
(10) Pub. No.: US 2006/0221296 A1
(43) Pub. Date: Oct. 5, 2006

(54) Method for manufacturing liquid-crystal display device

(75) Inventors: Yasuo Fujita, Kumamoto (JP); Hiroshi Ohsaki, Kumamoto (JP); Takeshi Ohashi, Kumamoto (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: MITSUBISHI DENKI KABUSHIKI KAISHA, Chiyoda-ku (JP)

(21) Appl. No.: 11/365,518

(22) Filed: Mar. 2, 2006

(30) Foreign Application Priority Data
Apr. 4, 2005 (JP) 2005-107883

(51) Int. Cl. G02F 1/13

(52) U.S. Cl. 349/187

(57) ABSTRACT

A method for manufacturing a liquid-crystal display device includes forming element segments in lines and rows on a first substrate, the element segment having a liquid-crystal sealed-in region and an electrode line extending from inside the liquid-crystal sealed-in region and has a terminal electrode and an illumination test electrode pad, forming a resin film and a common electrode formed from a translucent conductive film on a second substrate, bonding together the first and second substrates, cutting the first substrate and the second substrate and dividing into stick substrates. An area on the second substrate where the common electrode and the resin film are formed includes the liquid-crystal sealed-in region and an area opposing the terminal electrodes. The element segment is arranged in numbers and in a line on the stick substrate. The terminal electrode is arranged between the liquid-crystal sealed-in regions in the element segment and in an adjacent element segment.

### BACKGROUND OF THE INVENTION

1. Field of the Invention

The present invention relates to a method for manufacturing a liquid-crystal display, and more particularly, to a manufacturing method suitable for a compact active matrix liquid-crystal display.

2. Description of the Related Art

A liquid-crystal display device is usually manufactured as follows. An array substrate, which is a first substrate, and an opposing substrate, which has a common electrode and a resin film and is a second substrate, form a pair, with a sealant sandwiched between edges of respective element segments of the substrates. Specifically, a pixel region—where thin-film transistors and pixel electrodes connected thereto are arranged in a matrix pattern—and an element segment—including electrode lines, such as signal lines having terminal electrodes connected to the thin-film transistors and scan lines—are arranged on the array substrate. The substrates are bonded together so as to oppose each other with the sealant sandwiched therebetween. After sealing of liquid crystal in the liquid-crystal sealed-in region enclosed by the array substrate, the opposing substrate, and the sealant, the substrates are sliced on per-element-segment basis.

In reality, the element segment is often formed in a plurality of lines and rows, in consideration of ease of mass production. In that case, there is employed a method of: bonding together substrates with sealant sandwiched therebetween; slicing the substrates in the direction of the line or row, to thus separate the substrates such that the plurality of element segments are arranged in line; and subsequently sealing liquid crystal in the plurality of liquid-crystal sealed-in regions (see, e.g., JP-A-2004-317982 (pg. 3, FIG. 5)).

Illumination of the liquid-crystal display device is usually inspected by bringing a probe needle into contact with the terminal electrode, and applying a voltage to the terminal electrode, to thus activate the thin-film transistors by way of the san lines and the signal lines. However, when the space between the terminal electrodes becomes smaller as a result of resolution of the liquid-crystal display device becoming higher, a problem arises in terms of the machining accuracy of the probe needle and the accuracy of a contact point. For this reason, there is disclosed a method for carrying out an illumination test by separately providing a simple-test electrode used for simply testing illumination (see, e.g., JP-A-2003-322874 (pg. 3, FIG. 1)).

In general, when a voltage is applied to the terminal electrode, there arises a problem of corrosion of the terminal electrode, which is caused by an electrochemical phenomenon involving moisture stemming from dew condensation or the like. In order to solve the problem, there is disclosed a structure for covering the terminal electrodes with an insulating material, such as SiO₂ or the like (see, e.g., JP-A-58-178325 (pg. 2, FIGS. 1 and 2)).

JP-A-2004-317982 describes a process of forming element segments on a substrate in a plurality of lines and rows; slicing the substrate in the direction of the line or row, to thus separate the substrate such that the plurality of element segments are arranged in line; and sealing liquid crystal in liquid-crystal sealed-in regions. In this case, the array substrate and the opposing substrate are bonded together with sealant while a gap, which corresponds to the thickness of the sealant, exists between the substrates. The terminal electrodes of the array substrate located between the liquid-crystal sealed-in region and an adjacent liquid-crystal sealed-in region oppose opposing electrodes on the opposing substrate with the gap therebetween. No specific problem arises if the respective element segments are separated from each other in this state, to thus manufacture the individual liquid-crystal display devices. However, a problem will arise when an illumination test is carried out by applying a voltage to the electrodes and the wires in this state. The reason for this is that a potential difference arises between the terminal electrode and the opposing electrode if the voltage is applied for the illumination test. When a water droplet has arisen between the substrates for reasons of dew condensation, electro-chemical reaction occurs between the electrodes by way of the water droplet. Namely, the terminal electrode becomes corroded for reasons of occurrence of an electro-chemical reaction, thereby causing a problem of occurrence of a display failure in the liquid-crystal display device.

In order to solve this problem, there is also a method for coating the surface of the terminal electrode with an insulating substance. However, the terminal electrodes are situated in the gap between the substrates, which poses difficulty in coating. Moreover, even if the terminal electrodes can have been coated, connection resistance, which arises when an IC is connected to the terminal electrodes, increases, thereby raising another problem of deterioration in display characteristics.

Still another conceivable method is to pattern the opposing electrodes so as to be formed solely within the liquid-crystal sealed-in region, thereby preventing formation of the opposing electrodes in an area opposing the terminal electrodes. However, this method also encounters a problem of an increase in patterning cost. When a desire exists for a smaller display device, the accuracy of patterning of the opposing electrodes becomes more rigorous. As a result, the opposing electrodes extend beyond the liquid-crystal sealed-in region, which eventually raises another problem of the opposing electrodes opposing the terminal electrodes.

### SUMMARY OF THE INVENTION

The present invention prevents occurrence of corrosion of terminal electrodes, which would otherwise be caused when a voltage used for illumination test develops between a terminal electrode and the opposing electrode, in the case of a structure where the substrates are sliced while the plurality of element segments are arranged in line and where the terminal electrodes on the array substrate and the opposing electrodes on the opposing substrate oppose each other outside the liquid-crystal sealed-in region with a gap therebetween.

According to an aspect of the present invention, a method for manufacturing a liquid-crystal display device includes a step of forming element segments in a plurality of lines and rows on a first substrate, each of the element segments having a liquid-crystal sealed-in region and an electrode line which extends from inside the liquid-crystal sealed-in region and has a terminal electrode and an illumination test electrode pad outside the liquid-crystal sealed-in region, a step of forming a resin film and a common electrode formed from a translucent conductive film on a second substrate, a step of bonding together by way of a sealant formed in a boundary of the liquid-crystal sealed-in region the first substrate on which the element segments are formed and the second substrate on which the common electrode and the resin film are formed, a step of cutting the first substrate and the second substrate and dividing into stick substrates after the step of bonding together the first and second substrates, and a step of sealing liquid crystal within the liquid-crystal sealed-in region. An area on the second substrate where the common electrode and the resin film are formed includes the liquid-crystal sealed-in region and an area opposing the terminal electrodes. The element segment is arranged in numbers and in a line on the stick substrate. The terminal electrode is arranged between the liquid-crystal sealed-in region in the element segment and a liquid-crystal sealed-in region in an adjacent element segment. The illumination test electrode pad is exposed without opposing the opposing substrate.

A liquid-crystal display device is formed from an array substrate and an opposing substrate on which opposing electrodes are formed outside a liquid-crystal sealed-in region. There can be prevented corrosion of terminal electrodes, which poses a problem when an illumination test is carried out by application of a voltage to stick substrates-into which the substrates have been separated with a plurality of element segments being arranged in line on the respective stick substrates. Accordingly, the necessity for patterning a common electrode of the opposing substrate can be obviated, thereby yielding an advantage of the ability of manufacture an inexpensive liquid-crystal display device of improved yield.

### BRIEF DESCRIPTION OF THE DRAWINGS

FIG. 1 is a plan view of an array substrate employed in a first embodiment of the present invention;

FIG. 2 is a plan view of an element segment provided on the array substrate employed in the first embodiment of the present invention;

FIG. 3 is a plan view of an opposing substrate employed in the first embodiment of the present invention;

FIG. 4 is a top view of a partially-enlarged element segment on the opposing substrate of the first embodiment of the present invention;

FIG. 5 is a cross-sectional view of the partially-enlarged element segment on the opposing substrate of the first embodiment of the present invention;

FIG. 6 is an external view of a stick substrate of the first embodiment of the present invention;

FIG. 7 is a top view of the neighborhood of a terminal electrode on an array substrate of the first embodiment of the present invention;

FIG. 8 is a cross-sectional view of the stick substrate of the first embodiment of the present invention;

FIG. 9 is a cross-sectional view of a stick substrate according to another mode of the first embodiment of the present invention;

FIG. 10 is a top view of the neighborhood of the terminal electrode according to another mode of the first embodiment of the present invention;

FIG. 11 is a cross-sectional view of a stick substrate according to the other mode of the first embodiment of the present invention;

FIG. 12 is a cross-sectional view of a stick substrate according to a second embodiment of the present invention; and

FIG. 13 is a cross-sectional view of a stick substrate according to a third embodiment of the present invention.

### DETAILED DESCRIPTION OF THE INVENTION

### First Embodiment

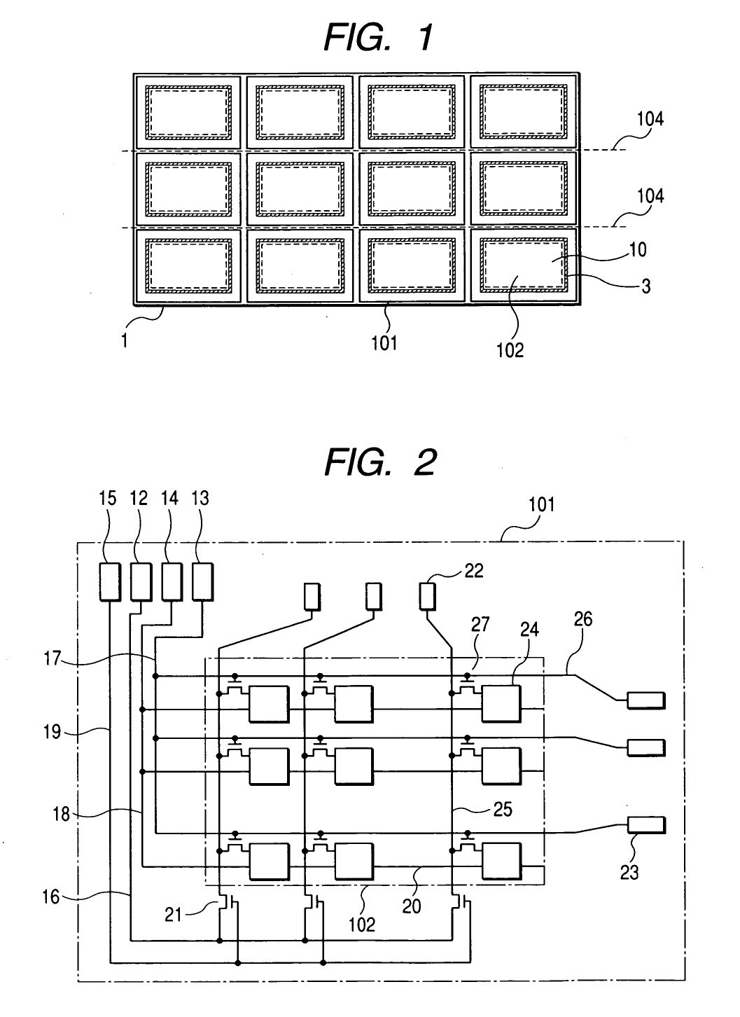

A method for manufacturing a liquid-crystal display device of a first embodiment will be described hereinbelow. As shown in FIG. 1, a method for manufacturing a liquid-crystal display device according to the first embodiment begins with a process for arranging element segments 101 shown in FIG. 2 in a plurality of lines and rows on an array substrate 1, which serves as a first substrate. The element segment 101 is a unit which is to become a liquid-crystal display device. In FIG. 1, 3-by-4 element segments 101; namely, a total of twelve element segments 101, are formed. A liquid-crystal sealed-in region 102 is provided within the element segment 101, and cutting lines 104, along which the substrate 1 is divided into three pieces such that each piece includes four element segments 101, are also shown. However, the liquid-crystal sealed-in region and the cutting lines 104 will be described later.

The element segment 101 will now be described in detail. As shown in FIG. 2, a plurality of source lines 25 and gate lines 26, which are made from metal such as aluminum and serve as electrode lines, are formed in the element segment 101 on the array substrate 1 so as to cross each other at right angles. Thin-film transistors 27 connected to the electrode lines are placed in the vicinity of the points of intersection of the electrode lines. Pixel electrodes 24 connected to the thin-film transistors 27 are arranged in the shape of a matrix. A translucent conductive material, such as an ITO or the like, or a metallic material having high optical reflectance, such as aluminum, is used for the pixel electrode 24. A capacitor electrode line 20 used for forming accumulated capacitance is laid below each of the pixel electrodes 24 by way of an (unillustrated) insulating film, and is formed simultaneously with the gate line 26. The capacitor electrode line 20 is connected to an opposing electrode 11 of an opposing substrate 2. The accumulated capacitance is formed to maintain the signal voltage held by the pixel electrode 24 during an inactive state of the drive voltage subsequent to a period during which the drive voltage is applied to the gate electrode line 26.

Concurrently with formation of the pixel electrodes 24, gate terminal electrodes 23, source terminal electrodes 22, and electrode pads 12 to 15 for use in inspecting illumination (hereinafter called “illumination inspection electrode pads”) are formed outside of the liquid-crystal sealed-in region 102. Moreover, wires 16 to 19 for use in inspecting illumination (hereinafter called “illumination inspection wires”) are formed concurrently with formation of the source lines 25. Switching elements 21 are formed simultaneously with formation of the thin-film transistors 27. Here, the illumination inspection electrode pad 12 is connected to the illumination inspection wire 16 that is connected to the switch element 21 provided at one end of each source line 25. The illumination inspection electrode pad 13 is connected to respective single ends of the gate lines 26 by way of the illumination inspection electrode wire 17. The illumination inspection electrode pad 14 is connected to respective single ends of the capacitor electrode lines 20 by way of the illumination inspection electrode wire 18. The illumination inspection electrode pad 15 is connected to the illumination inspection electrode wire 19 that is a control wire for the switching element 21.

A resin film, such as polyimide, which serves as an alignment layer 10 is applied to the inside of the liquid-crystal sealed-in region 102 so as to cover all the pixel electrodes 24 of the array substrate 1 where the element segments 101, each being formed as mentioned previously, are arranged in a plurality of lines and columns. Subsequently, the surface of the alignment layer 10 is subjected to alignment treatment by means of rubbing. Moreover, when the alignment layer 10 is formed so as to cover the source terminal electrodes 22 and the gate terminal electrodes 23 of the array substrate 1, connection resistance, which arises when a driver circuit is connected to the terminal electrode, increases, which in turn induces a display failure. For these reasons, formation of the alignment layer 10 on the terminal electrodes is not desirable.

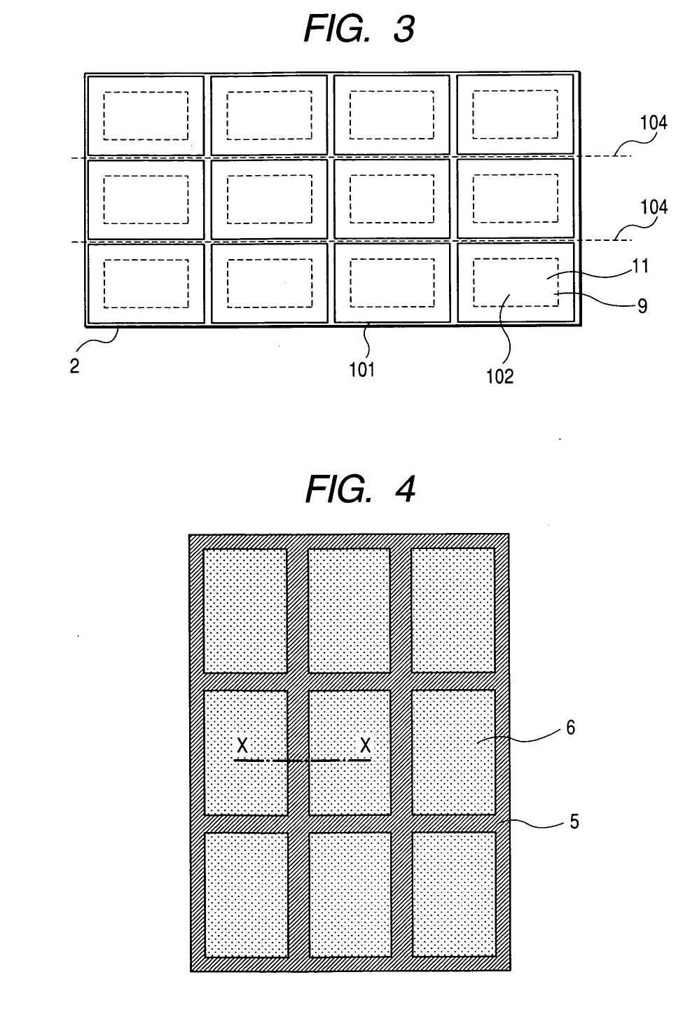

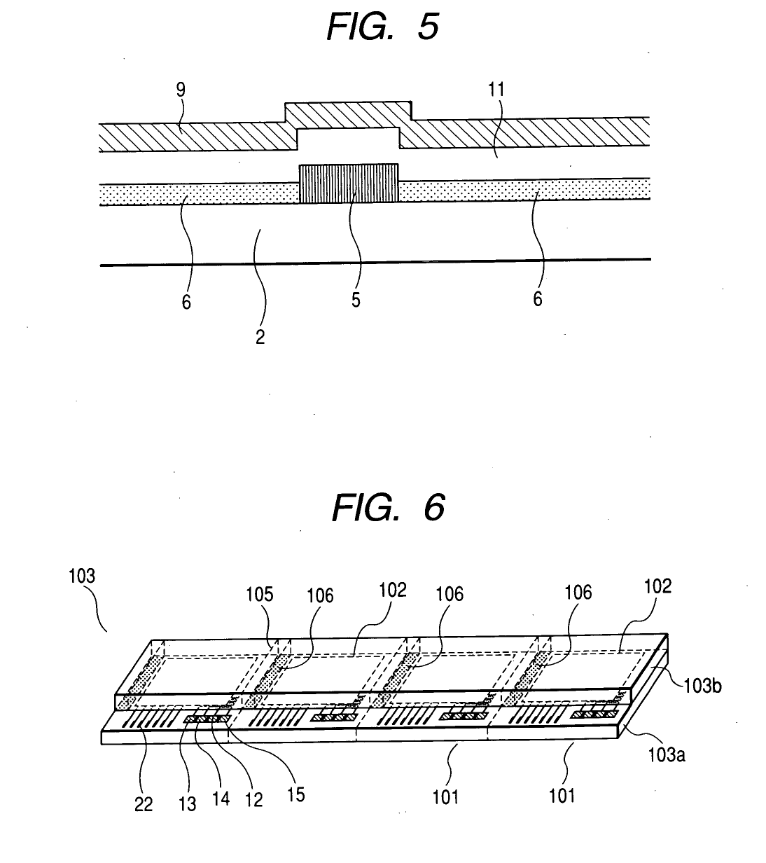

As shown in FIG. 3, the element segments 101 are arranged in a plurality of lines and rows on the opposing substrate 2 that is a second substrate. As in the case of the array substrate 1 shown in FIG. 1, 3-by-4 element segments 101; i.e., a total of twelve element segments 101, are formed. The liquid-crystal sealed-in region 102 is included in each of the element segments 101, and an alignment layer 9 is formed in the element segment 101. In the first embodiment, a filter having a red-colored layer, a blue-colored layer, and a green-colored layer is formed within each of the liquid-crystal sealed-in regions 102 of the opposing substrate 2 in response to the pixel electrodes 24 of the array substrate 1. FIG. 4 is a view showing a partially-enlarged color filter formed in the liquid-crystal sealed-in region 102 of the opposing substrate 2. A black matrix 5 patterned into a grid shape and a colored layer 6 formed in the opening section of the black matrix 5 are shown. The colored layers 6 of the respective opening sections are painted, in sequence, in red, blue, and green. The opposing electrode 11, which is formed from a translucent conductive film, is formed above the colored layer 6 and the black matrix 5. Further, a resin film, such as polyimide or the like, is formed in the top layer as the alignment layer 9 within the liquid-crystal sealed-in region 102. The structure of the color filter is shown in FIG. 5 in the form of a cross-sectional view taken along line X-X shown in FIG. 4.

As shown in FIG. 3, the area of the alignment layer 9 formed within the liquid-crystal sealed-in region 102 on the opposing substrate 2 is essentially identical in size with the area where the alignment layer 10 is formed within the liquid-crystal sealed-in region 102 on the array substrate 1. The first embodiment of the present invention is characterized in that the alignment layer 9, which is a resin film, is formed in an area other than the liquid-crystal sealed-in region 102 on the opposing substrate 2. Specifically, in the first embodiment, when the array substrate 1 and the opposing substrate 2 are bonded together, the alignment layer 9, which is a resin film, is formed also in the area of the opposing substrate 2 which opposes the gate terminal electrodes 23 located outside the liquid-crystal sealed-in region 102. An advantage, which would be yielded as a result of the alignment layer 9 being formed also in the area opposing the gate terminal electrodes 23, will be described later. As mentioned above, in the case of the opposing substrate 2 where the alignment layer 9 is formed, the surface of the alignment layer 9 is subjected to alignment processing involving rubbing as in the case of the array substrate 1.

In the array substrate 1 that has finished undergoing alignment treatment through rubbing, a sealant 3 is applied to boundaries of the twelve liquid-crystal sealed-in regions 102, and the opposing substrate 2 and the array substrate 1 are bonded together by way of the sealant 3 such that the alignment layers 9, 10 formed on the respective substrates oppose each other. When the sealant 3 is formed on the alignment layer 10, adhesion of the sealant 3 is deteriorated. For this reason, when the alignment layer 10 is formed, it is desirable to prevent the area where the alignment layer 10 is to be formed from overlapping the area to be coated with the sealant 3. Concurrently with bonding of the substrates, a transfer material, or the like, is formed in points of connection (not shown) such that the illumination inspection wire 18 and the opposing electrode 11 are electrically connected together. Subsequently, the thus-bonded substrates are sliced along the cutting lines 104 shown in FIGS. 1 and 3, the substrates are divided into three stick substrates 103, each of which includes four element segments 101. FIG. 6 shows the appearance of the stick substrate 103. As shown in FIG. 6, laminated bodies, which are formed by bonding the array substrate 1 and the opposing substrate 2 via the sealant 3 and slicing the thus-bonded substrates into pieces such that the plurality of element segments 101 are arranged in a line, will be hereinafter called stick substrates. A space enclosed by the respective liquid-crystal sealed-in regions 102 of the thus-sliced stick substrate 103 and the sealant 3 provided along the edges of the sealed-in regions 102 are sealed with liquid-crystal, whereby a liquid-crystal display device is formed in each element segment 101.

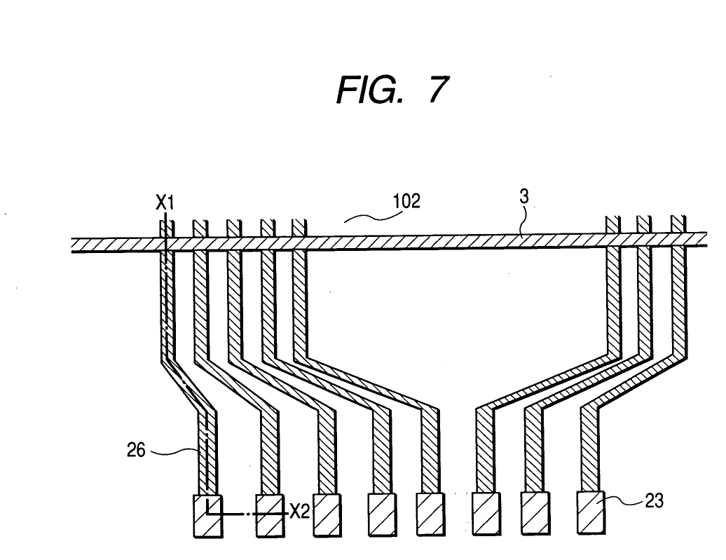

In FIG. 6, the stick substrate 103 includes a stick-shaped array substrate 103a, which is a part of the array substrate 1, and a stick-shaped opposing substrate 103b, which is a part of the opposing substrate 2. Four element segments 101 are arranged in line. Since the stick-shaped opposing substrate 103b is sliced so as to expose the illumination test electrode pads 12 to 15 and the source terminal electrodes 22 on the stick-shaped array substrate 103a, test of illumination becomes feasible. A cutting line 105 shows a cutting position where the stick substrate 103 is further separated into pieces of the element segments 101. By means of this slicing operation, the element segments 101 are separated from each other, to thus manufacture liquid-crystal display devices. The boundaries of the liquid-crystal sealed-in regions 102 correspond to positions which are sandwiched between the stick-shaped array substrate 103a and the stick-shaped opposing substrate 103b and where the sealant 3 is formed. In FIG. 6, the boundaries are illustrated as being parallelograms drawn by dotted lines. FIG. 6 shows that the terminal electrode opposing sections 106 are adjacent to the liquid-crystal sealed-in regions 102. Namely, the area oppose the gate terminal electrodes 23 shown in FIG. 2 (not shown in FIG. 6) are illustrated. Although not illustrated, the alignment layer 9, which is a resin film, is formed on the terminal electrode opposing sections 106 of the opposing substrate 2. In order to see in more detail the neighborhoods of the terminal electrode opposing sections 106 opposing the gate terminal electrodes 23 on the stick-shaped array substrate 103a, FIG. 7 shows a top view of the stick-shaped array substrate 103a in the vicinity of the gate terminal electrodes 23.

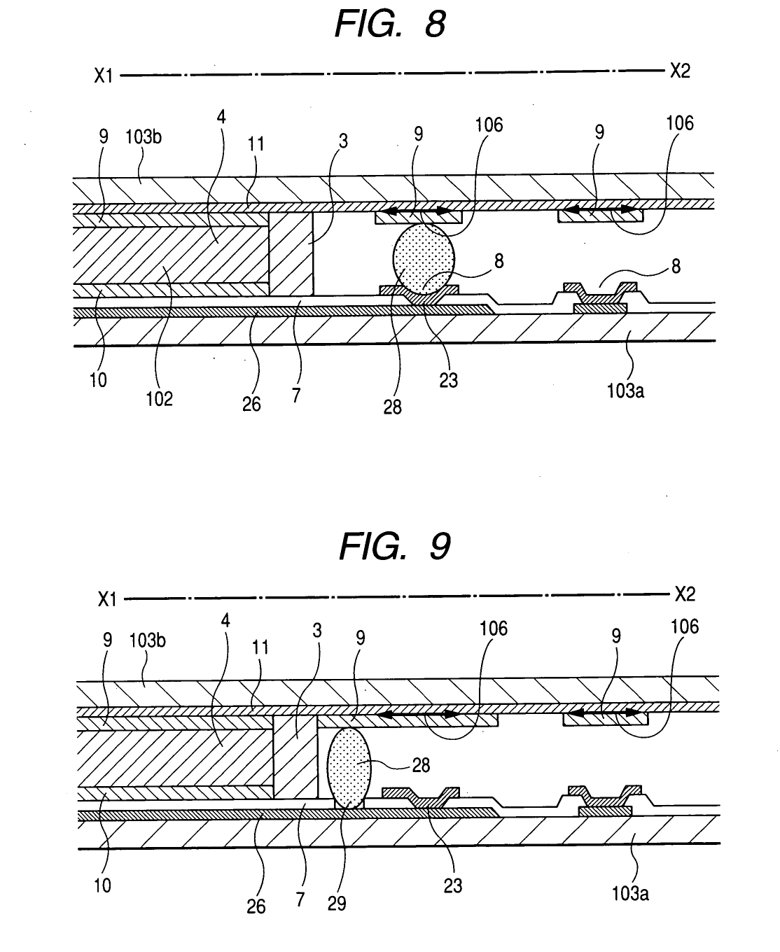

FIG. 7 is a view showing the neighborhood of the gate terminal electrodes 23 in an enlarged manner. Gate lines 26 are shown to be formed on the stick-shaped array substrate 103a and extend from the inside of the liquid-crystal sealed-in region 102 to the outside thereof by transversely crossing the sealant 3, and the gate terminal electrodes 23 are shown to be formed at ends of the gate lines 26. FIG. 8 shows a cross-sectional profile of the stick substrate 103 corresponding to the area indicated by line X1-X2 in FIG. 7. FIG. 8 shows that the stick-shaped array substrate 103a opposes the stick-shaped opposing substrate 103b at the gate terminal electrode 23 located outside the liquid-crystal sealed-in region 102. Both substrates are bonded together by means of the sealant 3, and the liquid crystal 4 is sealed in the liquid-crystal sealed-in region 102. In the region where the liquid crystal 4 is sealed, the stick-shaped opposing substrate 103b and the stick-shaped array substrate 103a are coated with the alignment layers 9, 10.

The gate lines 26, the insulating film 7 for covering the gate lines 26, and the gate terminal electrodes 23 connected to the gate lines 26 via a hole 8 formed in the insulating film 7 are formed in the area on the stick-shaped array substrate 103a where the liquid crystal 4 is not sealed. The opposing electrode 11 is formed in the counterpart area on the stick-shaped opposing substrate 103b. There is adopted a structure where the gate terminal electrodes 23 and the opposing electrode 11 oppose each other via a space defined by the sealant 3. FIG. 8 illustrates the terminal electrode 23 and an adjacent terminal electrode. The alignment layer 9, which is a resin film, is formed in each of the terminal electrode opposing sections 106 that oppose the terminal electrodes 23, thereby coating the opposing electrode 11 located below the terminal electrode opposing regions 106. Therefore, in the event that a water droplet 28 has arisen for reasons of dew condensation, the structure prevents the water droplet 28 from contacting the opposing electrode 11 in the terminal electrode opposing region 106.

Illumination of the thus-manufactured liquid-crystal display device is inspected as follows. First, a predetermined voltage for illumination purpose is applied to the illumination test wires 16 to 18 shown in FIGS. 2 and 6, and a control signal is applied to the switching element 21 from the illumination test wire 19, thereby activating the switching element 21. As a result, the respective thin-film transistors 27 are brought into electrical conduction, whereby the respective pixel electrodes 24 are illuminated. At this time, the voltage applied from the respective illumination test electrode pads 12 to 15 are applied to the gate terminal electrodes 23 and the source terminal electrodes 22 of the array substrate 1, as well, by way of the gate lies 26 and the source lines 25. Hence, a voltage difference arises between the opposing electrode 11 located in the terminal electrode opposing sections 106 and the gate terminal electrodes 23.

As shown in FIG. 8, in the first embodiment, the opposing electrode 11 located in the terminal electrode opposing regions 106 that oppose the gate terminal electrodes 23 is coated with the alignment layer 9, which is a resin film. In the event that the water droplet 28 has arisen for reasons of dew condensation with a potential difference existing between the opposing electrode 11 and the terminal electrode 23, electrochemical reaction does not arise. Consequently, corrosion of the gate terminal electrode 23 does not arise. The gate terminal electrodes 23 of the array substrate 1 are not coated with the alignment layer 10, which is a resin film. For this reason, when a driver IC (not shown) is connected to the terminal electrodes 23, occurrence of an increase in connection resistance can be prevented.

As shown in FIG. 9, the alignment layer 9 is formed not only in the terminal electrode opposing regions 106 that oppose the gate terminal electrodes 23, but also in the area that is outside the liquid-crystal sealed-in region 102 and opposes the area where the gate lines 26 are usually coated with the insulating film 7. In this case, in the event that a defect, such as a pin hole 29, has arisen in the insulating film 7, occurrence of electrochemical reaction, which would otherwise be caused by the water droplet 28, can be hindered. Accordingly, corrosion of the gate terminal electrodes 23 can be prevented.

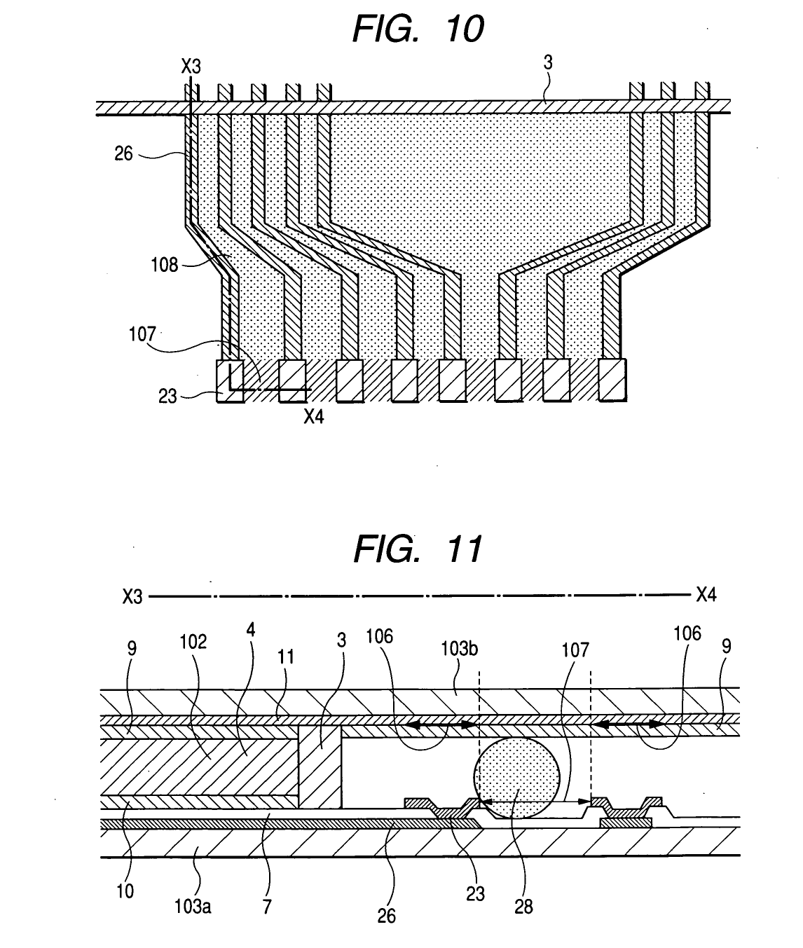

In order to describe another embodiment, a top view of the vicinity of the gate terminal electrodes 23 is shown in FIG. 10. The present embodiment has already stated that the location where the alignment layer 9 is formed includes the terminal electrode opposing regions 106 and the region opposing the area where the gate lines 26 are coated with the insulating film 7. However, the alignment layer 9 may also be formed in areas opposing narrows between wires or terminal electrodes, such as those shown in FIG. 10; narrow spaces 107 between the gate terminal electrodes 23 and adjacent terminal electrodes; or narrow spaces 108 between the gate lines 26, which are in communication with the gate terminal electrodes 23, and adjacent gate lines. A cross-sectional profile taken along line X3-X4 in FIG. 10 is shown in FIG. 11.

In FIG. 11, the alignment layer 9 is also formed in the areas opposing the narrow spaces 107 between the gate terminal electrodes 23 and adjacent gate terminal electrodes, and the water droplet 28 is present in the narrow spaces 107. Since neither the gate lines 26 nor the gate terminal electrodes 23 are situated in the narrow spaces 107 on the stick-shaped array substrate 103a, there may be a case where no electro-chemical reaction occurs even when the water droplet 28 is present. For instance, as shown in FIG. 11, even when an interval between wires is narrow, the water droplet 28 may contact the closest gate terminal electrode 23. Even in such a case, so long as the common electrode 11 located in positions that oppose the narrow spaces 107 is coated with the alignment layer 9, occurrence of electro-chemical reaction, which would otherwise arise between the common electrode 11 and the gate terminal electrodes 23 via the water droplet 28, can be prevented. Hence, there is also yielded an advantage of the ability to prevent occurrence of corrosion of the gate terminal electrodes 23.

### Second Embodiment

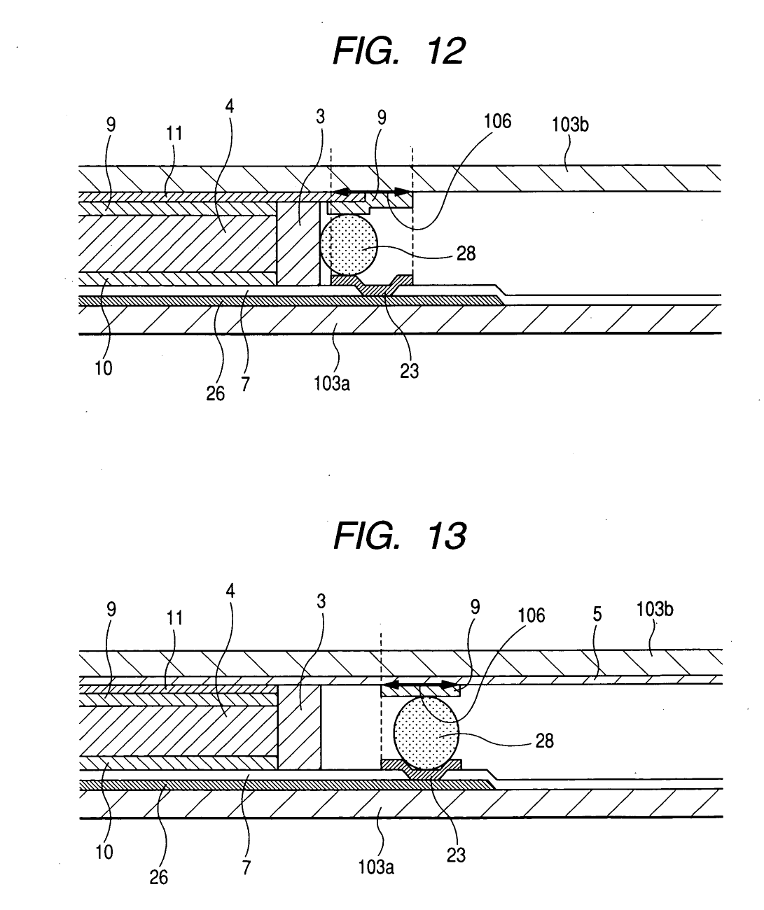

The first embodiment has described a case where the opposing electrode 11 is formed all over the opposing substrate 2. Application of the present invention is not limited to such an embodiment. For instance, there can be conceived a case where, even when patterning is performed such that the opposing electrode 11 is not formed in the terminal electrode opposing sections 106, the liquid-crystal sealed-in region 102 is broadened outside in order to extend the display region of the liquid-crystal display device to the greatest possible extent, as a result of which the interval between the sealant 3 and the gate terminal electrodes 23 becomes narrow. When the accuracy of pattern of the opposing electrodes 11 is insufficient with the interval between the sealant 3 and the gate terminal electrodes 23 being extremely narrow, the opposing electrodes 11 may extend to the terminal electrode opposing section 106. FIG. 12 shows a cross-sectional profile of the neighborhood of the gate terminal electrodes 23 achieved in such a case. In FIG. 12, a configuration—which is identical with that shown in the cross-sectional profile of the first embodiment shown in FIG. 8—is assigned the same reference numeral. As shown in FIG. 12, a structure understood to be achieved in this case is the opposing electrode 11, which is supposed to stay within the liquid-crystal sealed-in region 102, extending beyond the liquid-crystal sealed-in region 102, and the thus-extended portion opposing the gate terminal electrodes 23. Even when the opposing electrode 11 has extended beyond the liquid-crystal sealed-in region 102, the alignment layer 9 is formed in the terminal electrode opposing sections 106 in the second embodiment, to thus coat the extended opposing electrode 11. Hence, even when the water droplet 28 has arisen for reasons of dew condensation, occurrence of electrochemical reaction can be prevented, thereby hindering corrosion of the terminal electrodes.

### Third Embodiment

The first embodiment has described a case where the opposing electrode 11 formed from a translucent conductive film opposes the gate terminal electrodes 23 on the array substrate 1. However, the element opposes the gate terminal electrodes 23 is not limited to the opposing electrode 11. For instance, a conductive layer, such as the black matrix 5, which is connected to the opposing electrode 11 and always remains at the same electric potential as that of the opposing electrode 11, may also be available. FIG. 13 shows a condition where the present embodiment is applied to the structure where the black matrix 5 opposes the gate terminal electrodes 23.

In FIG. 13, the configuration which is equal to that shown in FIG. 8 is assigned the same reference numeral. FIG. 13 differs from FIG. 8 in that the opposing electrode 11 in FIG. 13 is formed solely within the liquid-crystal sealed-in region 102. Therefore, the opposing electrode 11 does not exist in the terminal electrode opposing sections 106 outside the liquid-crystal sealed-in region 102 on the stick-shaped opposing substrate 103b, and the black matrix 5 is formed in place of the opposing electrode 11. As mentioned above, the area that is formed from the conductive layer maintained at the same electric potential as that of the opposing electrode 11 can also be called an opposing electrode in a broad sense, and the same advantage as that yielded in the first embodiment is yielded. On the stick-shaped opposing substrate 103b shown in FIG. 12, the alignment layer 9 is formed solely on the black matrix 5 in the location corresponding to the terminal electrode opposing section 106. However, the alignment layer 9 may also be formed in an area opposing the location where the gate wires 26 are coated with the insulating film 7, or in the areas opposing the small spaces 107, 108. Although the third embodiment has described the black matrix 5 by means of taking the black matrix as the conductive layer, the present embodiment is not limited to this.

Although the first through third embodiments have described that the array substrate 1 using the thin-film transistors 27, the embodiments are not limited to this. Even when the source terminal electrodes rather than the gate terminal electrodes are used, the same advantage can be yielded. Depending on a material, there may also arise a case where corrosion arises not in the terminal electrodes 23 but in the opposing electrode 11. Even in such a case, occurrence of electro-chemical reaction can be prevented by application of the present embodiment, to thus hinder corrosion.

In the first through third embodiments, the alignment layer 9, which is a resin film, is formed also on the terminal electrode opposing sections 106 on the opposing substrate 2, which oppose the terminal electrodes 23 on the array substrate 1. Accordingly, there can be prevented corrosion of the terminal electrodes 23 in the area, where no liquid crystal exists, between the liquid-crystal sealed-in region 102 and an adjacent liquid-crystal sealed-in region, which would cause a problem when the stick-shaped substrate 103 is subjected to an illumination test.

What is claimed is:

1. A method for manufacturing a liquid-crystal display device, comprising:
a step of forming element segments in a plurality of lines and rows on a first substrate, each of the element segments having a liquid-crystal sealed-in region and an electrode line which extends from inside the liquid-crystal sealed-in region and has a terminal electrode and an illumination test electrode pad outside the liquid-crystal sealed-in region;
a step of forming a resin film and a common electrode formed from a translucent conductive film on a second substrate;
a step of bonding together by way of a sealant formed in a boundary of the liquid-crystal sealed-in region the first substrate on which the element segments are formed and the second substrate on which the common electrode and the resin film are formed;
a step of cutting the first substrate and the second substrate and dividing into stick substrates after the step of bonding together the first and second substrates; and
a step of sealing liquid crystal within the liquid-crystal sealed-in region, wherein
an area on the second substrate where the common electrode and the resin film are formed includes the liquid-crystal sealed-in region and an area opposing the terminal electrodes,
the element segment is arranged in numbers and in a line on the stick substrate,
the terminal electrode is arranged between the liquid-crystal sealed-in region in the element segment and a liquid-crystal sealed-in region in an adjacent element segment, and
the illumination test electrode pad is exposed without opposing the opposing substrate.

2. The method for manufacturing a liquid-crystal display device according to claim 1, wherein
the area on the second substrate where the resin film is formed includes an area which is outside the liquid-crystal sealed-in region and opposes the electrode line in connection with the terminal electrode.

3. The method for manufacturing a liquid-crystal display device according to claim 1, wherein
the area on the second substrate where the resin film is formed includes an area which is outside the liquid-crystal sealed-in region and opposes a gap between the terminal electrode and the adjacent terminal electrode.

4. The method for manufacturing a liquid-crystal display device according to claim 2, wherein
the area on the second substrate where the resin film is formed includes an area which is outside the liquid-crystal sealed-in region and opposes a gap between the electrode line in connection with the terminal electrode and an adjacent electrode line.

5. The method for manufacturing a liquid-crystal display device according to claim 3, wherein
the area on the second substrate where the resin film is formed includes an area which is outside the liquid-crystal sealed-in region and opposes a gap between the electrode line in connection with the terminal electrode and an adjacent electrode line.

6. The method for manufacturing a liquid-crystal display device according to claim 1, further comprising:
a step of inspecting illumination by applying a voltage to the illumination test electrode pad after the step of sealing liquid crystal, wherein
a potential difference arises between the terminal electrode and the common electrode in the step of inspecting illumination.

7. The method for manufacturing a liquid-crystal display device according to claim 2, further comprising:
a step of inspecting illumination by applying a voltage to the illumination test electrode pad after the step of sealing liquid crystal, wherein
a potential difference arises between the terminal electrode and the common electrode in the step of inspecting illumination.

8. The method for manufacturing a liquid-crystal display device according to claim 3, further comprising:
a step of inspecting illumination by applying a voltage to the illumination test electrode pad after the step of sealing liquid crystal, wherein
a potential difference arises between the terminal electrode and the common electrode in the step of inspecting illumination.

9. The method for manufacturing a liquid-crystal display device according to claim 4, further comprising:
a step of inspecting illumination by applying a voltage to the illumination test electrode pad after the step of sealing liquid crystal, wherein
a potential difference arises between the terminal electrode and the common electrode in the step of inspecting illumination.

10. The method for manufacturing a liquid-crystal display device according to claim 5, further comprising:
a step of inspecting illumination by applying a voltage to the illumination test electrode pad after the step of sealing liquid crystal, wherein
a potential difference arises between the terminal electrode and the common electrode in the step of inspecting illumination.
